(19) United States
(12) Patent Application Publication
(10) Pub. No.: US 2009/0095922 A1
(43) Pub. Date: Apr. 16, 2009

(54) METHOD OF REPAIRING A POLYMER MASK

(76) Inventors: Oug-Ki Lee, Seoul (KR); Jong-Kook Park, Gyeonggi-do (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/282,662

(22) PCT Filed: May 11, 2007
(86) PCT No.: PCT/KR07/02333

§ 371 Date: Sep. 12, 2008

(30) Foreign Application Priority Data
May 18, 2006 (KR) 10-2006-0044589
Mar. 26, 2007 (KR) 10-2007-0029396

(51) Int. Cl. G21G 5/00

(52) U.S. Cl. 250/492.1

(57) ABSTRACT

A method of repairing defects to a patterned polymer mask for a photolithography process is described, illustrated, and claimed. Generally, there are two types of defects to a polymer mask, which are an ink spot on a transparent polymer substrate and an ink void in a patterned area. The ink spot is repaired by an effective ablation by a laser that does not substantially affect a transparency of the polymer substrate. The ink void is repaired by various embodiments using laser-assisted touch-up processes, wherein the laser-assisted touch-up restores the void to block UV light during a photolithography exposure.

### TECHNICAL FIELD

Exemplary embodiments of the present invention relate to a method of repairing a polymer mask. More particularly, exemplary embodiments of the present invention relate to a method of repairing fabrication defects to a polymer mask such as spots and voids using a laser.

### BACKGROUND ART

A polymer mask is a type of photolithography mask used for a contact exposure or a near-field imaging. The polymer mask may include non-transparent patterns on a transparent and flexible polymer substrate. The polymer mask may be fabricated by forming a non-transparent layer on an entire area of a flexible substrate, and then patterning the non-transparent layer by a conventional photolithography process. The polymer mask may be a quick and economical solution for a large-area lithography having moderate resolution. For example, the polymer mask is a good solution for achieving a high-density printed circuit board (PCB), which requires quick and economical means to expose a large area. A conventional example of the polymer mask may include a patterned UV curing ink on a polyethylene terephthalate (PET) substrate. To fabricate this, the UV curing ink is spray-coated on a large PET substrate, and then the substrate is exposed to a UV light by a photolithography process to selectively cure the ink, thereby forming patterns.

Due to a developing process followed by the lithography exposure of the large area, the PTE mask is hard to be fabricated without generating defects. Defects may usually include voids on ink-patterned area resulted from an improper exposure, and ink spots on a transparent area resulted from an improper developing. Sizes of these defects may be in a range of a few micrometers to a few millimeters. The defects may be repaired before using the polymer mask for performing the lithography. However, repairing these defects is difficult and time-consuming. Especially, a manual touch-up for repairing the voids in micron-scale may be challenging. Removing the spot defect by using mechanical methods such as a polishing and a grinding may not be practical solutions either. Further, a selective ink removal by a laser ablation may be difficult due to a small difference in absorption between the polymer-based ink and the polymer substrate. What is needed therefore is an effective method of repairing the defects to the polymer mask.

### DISCLOSURE

### Technical Problem

Exemplary embodiments of the present invention provide a method of readily repairing defects to a polymer mask.

### Technical Solution

In a method of repairing a patterned polymer substrate in accordance with a first aspect of the present invention, a transparent polymer substrate having first and second surfaces, and a patterned layer on the first surface of the polymer substrate is provided. Defects to the patterned layer and the first surface of the polymer substrate are then detected. Here, the defects include a spot defect and a void defect. A laser irradiation removes the spot defect. The void defect is then touched up.

In a method of repairing a patterned polymer mask for performing a photolithography process in accordance with a second aspect of the present invention, a transparent polymer substrate having first and second surfaces, and a non-transparent patterned layer on the first surface of the polymer substrate are provided. Defects to the patterned layer and the first surface of the polymer substrate are then detected. Here, the defects include a spot defect and a void defect. The spot defect is removed by a laser irradiation. Here, the laser irradiation maintains transparency of the polymer substrate. The void defect is then restored by a laser-assisted touch-up.

In a method of repairing a defect to a patterned polymer mask for performing a photolithography process in accordance with a third aspect of the present invention, a transparent polymer substrate having first and second surfaces and a non-transparent patterned layer on the first surface of the polymer substrate are provided. A spot defect to the first surface of the polymer substrate is then detected. The spot defect is removed by a laser irradiation. Here, the laser irradiation is sufficiently provided to induce an effective ablation for substantially maintaining transparency of the first surface of the polymer substrate.

According to one exemplary embodiment, the laser irradiation for the effective ablation may be performed using a pulsed laser having an irradiance in a range of about 10⁶ W/cm² to 10¹⁵ W/cm². Alternatively, the laser irradiation may be performed using a pulsed UV laser having a wavelength in a range of about 150 nm to about 400 nm. Further, the laser irradiation may be performed using a near-field imaging that uses a mask for forming a beam spot shape incident on the spot defect. Furthermore, the laser irradiation may be performed using a far-field imaging that has a beam profile having a TEM₀₀ mode in the Gaussian distribution.

According to another exemplary embodiment, the laser irradiation may form a crater having a depth of about 0.1 μm to 50 μm. Further, the crater may have a concave shape crater. Furthermore, the crater may be covered by a polymer emulsion having a refractive index substantially similar to that of the polymer substrate.

In a method of repairing a patterned polymer mask for a photolithography process in accordance with a fourth aspect of the present invention, a transparent polymer substrate having first and second surfaces and a non-transparent patterned layer on the first surface of the polymer substrate are provided. A void defect to the patterned layer is then detected. A laser is irradiated to the void defect to form a blind hole. The blind hole is then filled with a non-transparent filler-ink.

According to an exemplary embodiment, the method may further include removing an excessive amount of the filler-ink around the blind hole to fill the blind hole with the ink.

According to another exemplary embodiment, the laser irradiation may be performed using a pulsed laser having an irradiance in a range of about 10⁶ W/cm² to 10¹⁵ W/cm². Alternatively, the laser irradiation may be performed using a pulsed UV laser having a wavelength in a range of about 150 nm to about 400 nm. Further, the laser irradiation may be performed using a near-field imaging that uses a mask for forming a beam spot shape incident on the spot defect. Furthermore, the laser irradiation may be performed using a far-field imaging that has a beam profile having a TEM₀₀ mode in the Gaussian distribution.

According to still another exemplary embodiment, the blind hole may have a depth in a range of about 1 μm to 50 μm.

According to yet still another exemplary embodiment, filling the blind hole with the filler-ink may be performed using an injection nozzle. Further, the injection nozzle may include an inkjet nozzle cartridge for delivering droplets of the filler-ink to the blind hole, and a needle-type dot marker for delivering dots of the filler-ink through a needle tube adjacent to the blind hole.

In a method of repairing a patterned polymer mask for a photolithography process in accordance with a fifth aspect of the present invention, a transparent polymer substrate having first and second surfaces, and a non-transparent patterned layer on the first surface of the polymer substrate are provided. A void defect on the patterned layer is then detected. A first laser is irradiated to the void defect to expose the first surface of the polymer substrate. A second laser is then irradiated to the exposed first surface to form a diffractive structure for trapping an incident light.

According to one exemplary embodiment, the first laser irradiation may be performed using a pulsed laser with an irradiance in a range of about 10⁶ W/cm² to 10¹⁵ W/cm². Alternatively, the first laser irradiation and the second laser irradiations may be performed using a pulsed UV laser having a wavelength in a range of about 150 nm to about 400 nm. Furthermore, the first laser irradiation may be performed using an ArF excimer laser at 193 nm with a laser energy density in a range of about 0.1 J/cm² to about 100 J/cm². The second laser irradiation may be performed using an ArF excimer laser at 193 nm with a laser energy density in a range of about 0.01 J/cm² to about 0.5 J/cm².

According to another exemplary embodiment, the first laser irradiation and the second laser irradiation may be performed using a near-field imaging that uses a mask for forming a beam spot shape incident on the spot defect. Alternatively, the first laser irradiation and the second laser irradiation may be performed using a far-field imaging that has a beam profile with a TEM₀₀ mode in the Gaussian distribution.

According to still another exemplary embodiment, the diffractive structure may have a plurality of micro-scaled cones.

In a method of repairing a patterned polymer mask for a photolithography process in accordance with a sixth aspect of the present invention, a transparent polymer substrate having first and second surfaces, and a non-transparent patterned layer on the first surface of the polymer substrate are provided. A void defect on the patterned layer is then detected. A transparent photosensitive layer including at least one kind of photosensitive particles is formed over the void defect. A laser is irradiated to the photosensitive layer to photochemically change a color of the photosensitive layer.

According to one exemplary embodiment, the photosensitive layer may include a mixture of titanium dioxide particles in a polymer emulsion. Further, the titanium dioxide particles may have an average size of about 1 nanometer to 1,000 nanometers.

According to still another exemplary embodiment, the laser irradiation may be performed using a pulsed laser with an irradiance in a range of about 10⁶ W/cm² to 10¹⁵ W/cm². Alternatively, the laser irradiation may be performed using a pulsed UV laser with a wavelength in a range of about 150 nm to about 400 nm. Further, the laser irradiation may be performed using a near-field imaging that uses a mask for forming a beam spot shape incident on the photosensitive layer. Furthermore, the laser irradiation may be performed using a far-field imaging that has a beam profile with a TEM₀₀ mode in the Gaussian distribution.

In a method of repairing a patterned polymer mask for a photolithography process in accordance with a seventh aspect of the present invention, a transparent polymer substrate having first and second surfaces, and a non-transparent patterned layer on the first surface of the polymer substrate are provided. A void defect to the patterned layer is then detected. A transparent photo-reactive layer including at least one kind of photo-reactive particles is formed over the void defect. A laser is then irradiated to the photo-reactive layer to react the photo-reactive particles with the laser, thereby creating carbonization debris.

According to one exemplary embodiment, the photo-reactive layer may include a mixture of polyimide particles in a polymer emulsion.

According to another exemplary embodiment, the laser irradiation may be performed using a pulsed laser having an irradiance in a range of about 10⁶ W/cm² to 10¹⁵ W/cm². Alternatively, the laser irradiation may be performed using a pulsed UV laser with a wavelength in a range of about 150 nm to about 400 nm. Further, the laser irradiation may be performed using a near-field imaging that uses a mask for forming a beam spot shape incident on the photo-reactive layer. Furthermore, the laser irradiation may be performed using a far-field imaging that has a beam profile with a TEM₀₀ mode in the Gaussian distribution.

In a method of repairing a patterned polymer mask for a photolithography process in accordance with an eighth aspect of the present invention, a transparent polymer substrate having first and second surfaces, and a non-transparent patterned layer on the first surface of the polymer substrate are provided. A void defect on the patterned layer is then detected. A non-transparent ink for preventing transmission of UV light is applied to the void defect. A laser is irradiated to the non-transparent ink to trim an overflow of the non-transparent ink beyond the patterned area on the first surface of the polymer substrate.

According to one exemplary embodiment, applying the non-transparent ink may be performed using an injection nozzle. The nozzle may include an inkjet nozzle cartridge for delivering droplets of the non-transparent ink to the void defect, and a needle-type dot marker for delivering dots of the non-transparent ink through a needle tube upon a contact on the void defect.

According to another exemplary embodiment, the non-transparent ink may include a mixture of at least one colorant in a polymer emulsion. Further, the non-transparent ink may include a UV curing ink that is cured by an exposure to UV light including a UV lamp and a pulsed UV laser before the laser irradiation.

According to still another exemplary embodiment, the laser irradiation may be performed using a pulsed laser with an irradiance in a range of about 10⁶ W/cm² to 10¹⁵ W/cm². Alternatively, the laser irradiation may be performed using a pulsed UV laser having a wavelength in a range of about 150 nm to about 400 nm. Further, the laser irradiation may be performed using a near-field imaging that uses a mask for forming a beam spot shape incident on the overflowed non-transparent ink. Furthermore, the laser irradiation may be performed using a far-field imaging that has a beam profile with a TEM₀₀ mode in the Gaussian distribution.

In a method of repairing a patterned polymer mask for a photolithography process in accordance with a ninth aspect of the present invention, a transparent polymer substrate having first and second surfaces, and a non-transparent patterned layer on the first surface of the polymer substrate are provided. A void defect to the patterned layer is then detected. A UV curing ink is applied to the void defect. A UV laser is partially irradiated to the UV curing ink to convert a region of the UV curing ink irradiated by the UV laser into an insoluble state. A region of the UV curing ink non-irradiated by the UV laser is then removed.

According to one exemplary embodiment, applying the non-transparent ink may be performed using an injection nozzle. The nozzle may include an inkjet nozzle cartridge for delivering droplets of the non-transparent ink to the void defect, and a needle-type dot marker for delivering dots of the non-transparent ink through a needle tube upon a contact on the void defect.

According to another exemplary embodiment, the UV laser irradiation may be performed using a pulsed laser with a wavelength in a range of about 150 nm to about 400 nm. Alternatively, the UV laser irradiation may be performed using a near-field imaging that uses a mask for forming a beam spot shape incident on the UV curing ink. Further, the UV laser irradiation may be performed using a far-field imaging that has a beam profile with a TEM₀₀ mode in the Gaussian distribution. Furthermore, the UV laser irradiation may be performed using a pulsed UV laser with a laser energy density in a range of about 0.001 J/cm² to about 0.05 J/cm².

In a method of repairing a patterned polymer mask for a photolithography process in accordance with a tenth aspect of the present invention, a transparent polymer substrate having first and second surfaces, and a non-transparent patterned layer on the first surface of the polymer substrate are provided. A transparent overlay having first and second surfaces, and an ink layer formed on the second surface of the transparent overlay to form an interface between the transparent overlay and the ink layer are then provided. A void defect on the patterned layer is detected. The transparent overlay is overlapped with the patterned layer of the polymer substrate to contact the ink layer to the void defect. A localized laser, which is substantially transmitted through the transparent overlay and substantially absorbed in the interface, is irradiated to the first surface of the transparent overlay to separate the ink layer from the second surface of the transparent overlay. The ink layer is then transcribed from the transparent overlay to the void defect.

According to one exemplary embodiment, the ink layer may include a mixture of at least one colorant in a polymer emulsion. Further, the ink layer may include a colored photoresist.

According to another exemplary embodiment, the laser irradiation may be performed using a pulsed UV laser with a wavelength in a range of about 150 nm to about 400 nm. Alternatively, the laser irradiation may be performed using a near-field imaging that uses a mask for forming a beam spot shape incident on the interface. Further, the laser irradiation may be performed using a far-field imaging that has a beam profile with a TEM₀₀ mode in the Gaussian distribution. Furthermore, the laser irradiation may be performed using a pulsed UV laser with a laser energy density in a range of about 0.001 J/cm² to about 0.05 J/cm².

### ADVANTAGEOUS EFFECTS

According to the present invention, the defects such as the spot defect, the void defect, etc., in the transparent polymer mask may be readily removed. Further, the methods of the present invention may easily repair the micro-sizes of voids. Therefore, the defects to the polymer mask for the photolithography process may be readily and effectively repaired.

### BRIEF DESCRIPTION OF DRAWINGS

The above and other features and advantages of the invention will become readily apparent by reference to the following detailed description when considered in conjunction with the accompanying drawings wherein:

FIG. 1A is a plan view illustrating types of defects on a polymer mask.

FIG. 1B is a cross-sectional view illustrating types of defects on the polymer mask in FIG. 1A;

FIGS. 2A to 2F are cross-sectional views and pictures illustrating a method of repairing a spot defect in accordance with a first exemplary embodiment of the present invention;

FIGS. 3A to 3E are cross-sectional views and a picture illustrating a method of repairing a void defect using an ink injection induced by a laser irradiation in accordance with a second exemplary embodiment of the present invention;

FIGS. 4A to 4E are cross-sectional views and a picture illustrating a method of repairing a void defect using a diffractive structure induced by a laser irradiation in accordance with a third exemplary embodiment of the present invention;

FIGS. 5A to 5C are cross-sectional views illustrating a method of repairing a void defect using a photo-printing in accordance with a fourth exemplary embodiment of the present invention;

FIGS. 6A to 6C are cross-sectional views illustrating a method of repairing a void defect using laser-induced carbonization in accordance with a fifth exemplary embodiment of the present invention;

FIGS. 7A to 7D are cross-sectional views illustrating a method of repairing a void defect using a localized ink application induced by a laser trim in accordance with a sixth exemplary embodiment of the present invention;

FIGS. 8A to 8D are cross-sectional views illustrating a method of repairing a void defect using a localized exposure of a UV curing ink induced by a laser irradiation in accordance with a seventh exemplary embodiment of the present invention; and

FIGS. 9A to 9D are cross-sectional views illustrating a method of repairing a void defect using a laser-induced ink transcription in accordance with an eighth exemplary embodiment of the present invention.

### BEST MODE FOR CARRYING OUT THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on”—or “connected to” another element or layer, it can be directly on or connected to the other element or layer or intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

This detailed description describes exemplary embodiments of processes consistent with the present disclosure, which addresses the problem associated with a polymer mask. Applications of the invention are not limited to the following exemplary embodiments. Although some exemplary embodiments refer to non-transparent inks on the PET substrate repaired by the ArF excimer laser at 193 nm, other types of non-UV-transparent layers and polymer substrates may be used with other types of lasers which are known to those skilled in the art.

A polymer mask for a photolithography exposure consists of an ink pattern on a transparent polymer substrate, distinctively dividing the mask into a patterned area and a transparent area (or alternatively a non-transparent and a transparent area). During a photolithography exposure, usually by a UV lamp or a UV laser, the patterned area blocks incident light and the rest of the transparent area transmit the light.

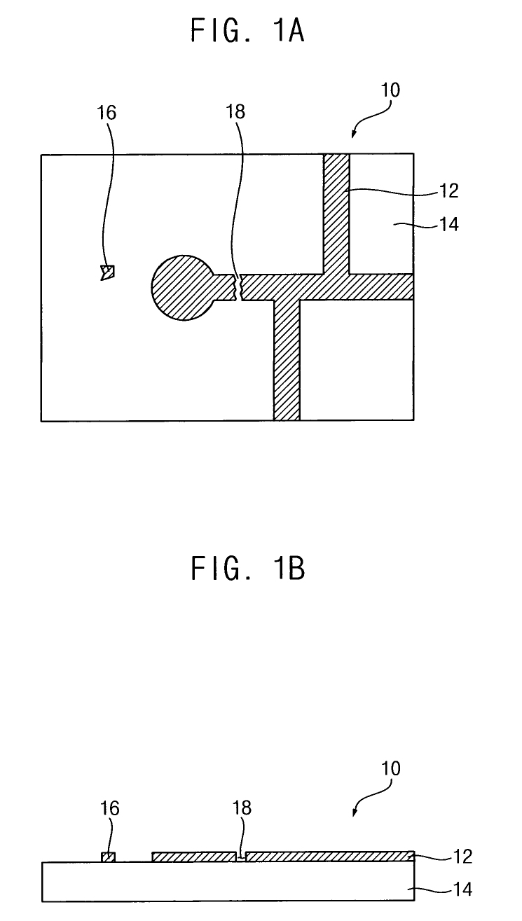

FIG. 1A is a plan view illustrating types of defects to a polymer mask, and FIG. 1B is a cross-sectional view illustrating types of defects to the polymer mask in FIG. 1A.

Referring to FIG. 1A, there are two distinctive types of defects in a polymer mask 10. One is formation of an ink spot 16 in a transparent polymer substrate 14, and the other is formation of an ink void 18 in a patterned area 12. A size of the defects, the ink spot 16 and the ink void 18, may range from a few micrometers to a few millimeters. In an electronic device or a printed circuit board using the polymer mask 10 for the lithography exposure, the undesired ink spot 16 in the transparent polymer substrate 14 may cause a short circuit, and the undesired ink void 18 in the patterned area 12 may result in an open circuit. FIG. 1B illustrates a cross-sectional view of the polymer mask 10 showing the ink spot 16 and the ink void 18.

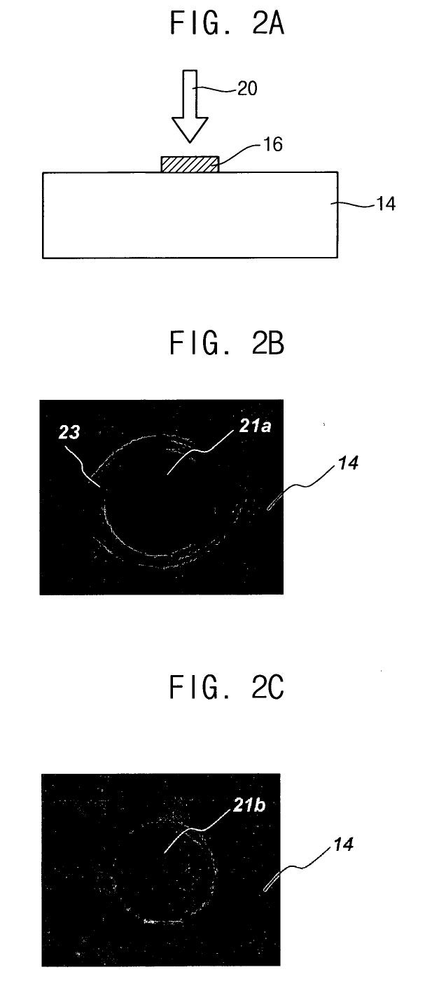

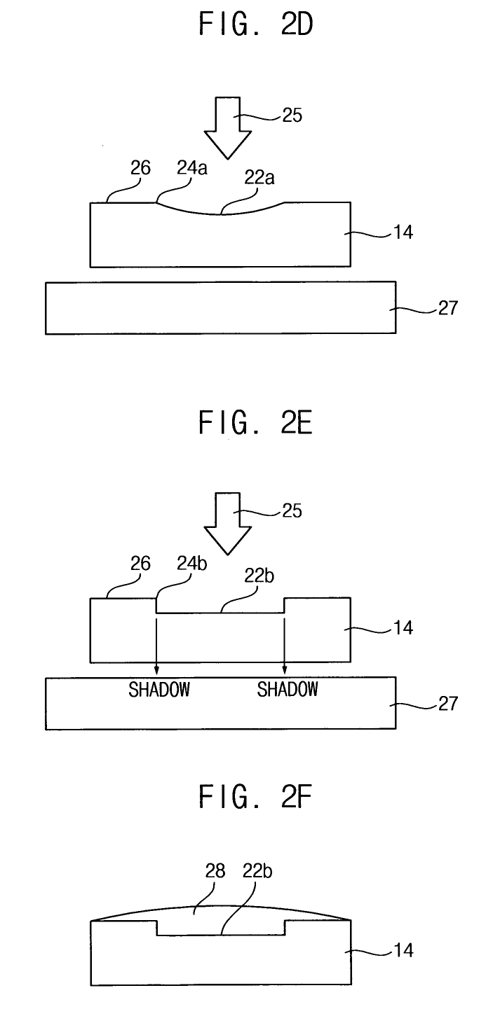

FIGS. 2A to 2F are cross-sectional views and pictures illustrating a method of, repairing a spot defect in accordance with a first exemplary embodiment of the present invention.

Referring to FIG. 2A, the ink spot 16 is exposed to a laser irradiation 20. In this exemplary embodiment, the laser irradiation may preferably use a pulsed UV laser. Further, the pulsed UV laser may include F₂ excimer laser at 157 nm, ArF excimer laser at 193 nm, KrCl excimer laser at 222 nm, KrF excimer laser at 248 nm, XeCl excimer laser at 308 nm, XeF excimer laser at 351 nm, and Nd:YAG (or Nd:YVO₄) lasers at 355 nm (frequency-tripled) or 266 nm (frequency-quadrupled), etc. Pulse duration of the above-mentioned laser may preferably be in range of femtoseconds to nanoseconds. Laser irradiation 20 may be a near-field imaging that uses a mask for forming a beam spot shape incident on the targeted ink spot 16. A far-field imaging may also be used for the irradiation 20. A beam profile of the irradiation 20 may be uniform enough, such as a TEM₀₀ in Gaussian distribution.

Ablation of a polymer by a laser beam depends on absorption properties of, the polymer and characteristics of the laser beam. The absorption property of a polymer may be denoted by the absorption coefficient (cm⁻¹), and determined by a depth of absorbed photons in the polymer material. The absorbed photons are reacted with atoms and molecules of the polymer to thereby lead the polymer material to excited states for instantaneous vaporization. A polymer with strong absorption property may have a higher absorption coefficient.

The characteristics of laser beam depend mainly on two properties, wavelength and pulse duration. This relationship may be expressed by I=E/(A·t), where I is irradiance [J/(cm² sec)], E is pulse energy of laser (Joule), A is an area of the laser beam (cm²) and t is pulse duration (sec). When the pulse duration is determined by a type of laser, the relationship may be expressed by D=E/A, where D is laser energy density (J/cm²). The pulse energy E may be described by Plank's equation of photonic energy, E=h·(c/λ), where h is the Plank's constant (6.62618×10⁻³⁴ J·sec), c is the speed of light (m/sec), and λ is wavelength (nm). Based on these relationships, the short pulse duration results in higher irradiance, and reduces heat transfer by quick absorption. The shorter wavelength increases the photonic energy, contributing to the improved optical absorption, and reduces absorption depth. When the pulse duration is fixed, a highly focused laser beam, resulting in a smaller area of the laser beam, significantly increases the laser energy density. However, the overflow of the laser energy density causes the excessive energy transformed into heat, resulting in thermal damages to a target. In general, an efficient ablation benefits from smaller laser wavelength and shorter pulse duration for both optical and thermal reasons. That is, when properties of a properly selected laser such as short pulse duration and high photonic energy are coupled with properties of a polymer material such as small absorption depth and low thermal conductivity, the excessive heat transfer is minimized by the efficient ablation resulting in cleaner material removal from a small heat-affected zone.

For example, a polymethyl methacrylate (PMMA) has a low absorption coefficient values around a few hundreds cm⁻¹ at 248 nm laser beam, which makes a long penetration depth. The absorption of the PMMA of about 248 nm laser irradiation is poor, thereby making the PMMA hard to have efficient ablation. In contrast, a polyimide (PI) has a much higher absorption coefficient values over 10⁵ cm⁻¹ at 248 nm laser beam. The penetration depth at the wavelength is relatively short, making the PI a good absorber to the incident laser beam. With an optimum laser energy density, a clean and efficient ablation is possible for the PI at 248 nm wavelength.

Referring to FIG. 2B, the PET is used for a transparent substrate 14, which is irradiated by a circular spot in 100 μm diameter from an excimer laser at 248 nm having pulse duration about 25 ns and laser energy density at 2 J/cm². Although the PET has a relatively high absorption coefficient of 1.6×10⁵ cm⁻¹ at 248 nm wavelength, the ablation is not highly efficient, showing recast of molten materials 23 around an irradiated area 21a. A thin layer of carbonized materials is also formed on the bottom of the irradiated area 21a. When the laser energy density is decreased towards the ablation threshold, the increased carbonization is found at the irradiated area 21a. On the other hand, when the laser energy density is increased, the recast 23 or the thermal damages are more evident around the irradiated area 21a. This is a proof of inefficient ablation of the PET substrate that makes the use of the 248 nm excimer laser marginal for repairing the ink spot 16.

In contrast, as shown in FIG. 2C, when the same PET substrate is irradiated with an excimer laser at 193 nm with about the substantially same pulse duration and the laser energy density, the ablation is much more efficient, resulting in clean bottom of the irradiated area 21b with no significant recast around the irradiated area 21b. The increased absorption of coefficient of the PET at 193 nm mainly contributes to the increased efficiency of the ablation. This makes the 193 nm excimer laser a better selection for the repair process.

Referring to FIG. 2D, after the laser irradiation 20, a repaired site 22a on the transparent polymer substrate 14 needs to maintain good optical transmission for a photolithography exposure 25. To maintain optical transmission of the transparent polymer substrate 14, the efficient ablation is needed to achieve minimized carbonization with a small heat-affected zone. It is preferable to have a smooth edge 24a of the repaired site 22a towards a polymer substrate surface 26. For example, the repaired site 22a may be formed to have a concave shape. A depth of the concave shape crater is preferably to be shallow, particularly less than 50 μm. During the photolithography exposure 25, the smooth edge 24a minimizes a formation of an edge shadow on a target 27 directly underneath the edge 24a of the repaired site 22a.

In contrast, when a repaired site 22b has a sharp and distinctive edge 24b as illustrated in FIG. 2E, incident UV light for the photolithography exposure 25 tends to be reflected or refracted away at the edge 24b. This leads to formation of a shadow on a target underneath the edge 24b, which forms defects during the photolithography exposure 25.

Thus, when the repaired site 22b has the edge 24b, this edge shadow may be reduced by forming a transparent layer 28 on the repaired site 22b as shown in FIG. 2F. The transparent layer 28 may be a polymer emulsion preferably having a matching index of refraction. The polymer emulsion may include a suspension of polymer particles in a liquid. When the liquid evaporates, the suspended polymer particles gather together and combine to form larger chains, thereby forming the transparent layer 28. Further, the transparent layer 28 may also be formed on the concave shaped repaired site 22a to enhance the light transmission in the photolithography process 25.

As mentioned above, when the laser irradiation for the efficient ablation is performed using a pulsed laser with an irradiance below about 10⁶ W/cm², the efficient ablation of the spot defect 16 may not be readily carried out. In contrast, when the laser irradiation for the efficient ablation is performed using a pulsed laser with an irradiance above about 10¹⁵ W/cm², the efficient ablation of the spot defect 16 may cause damages to the substrate 14. Therefore, the laser irradiation for the efficient ablation may be performed using a pulsed laser with an irradiance of about 10⁶ W/cm² to about 10¹⁵ W/cm².

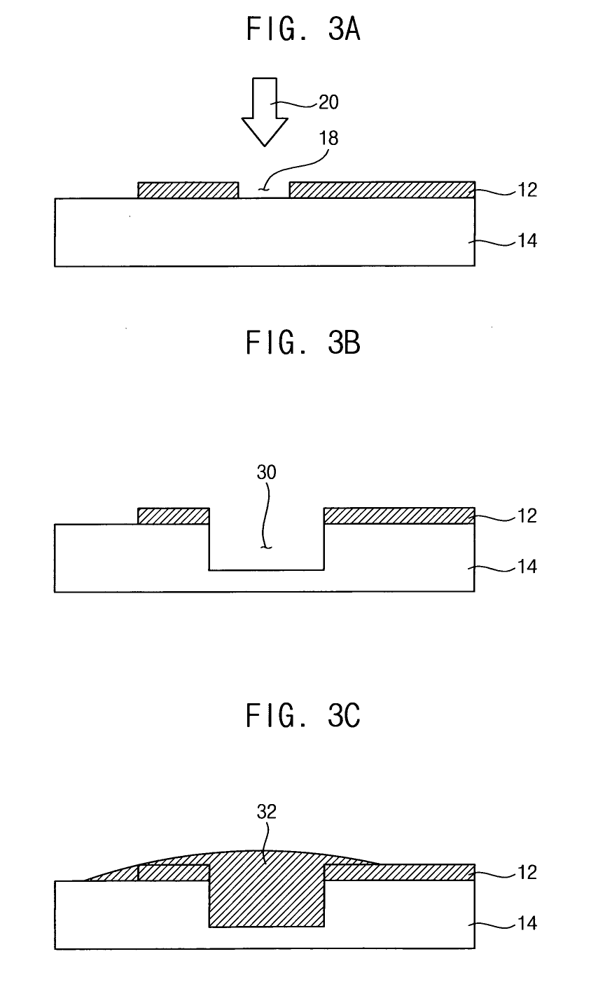

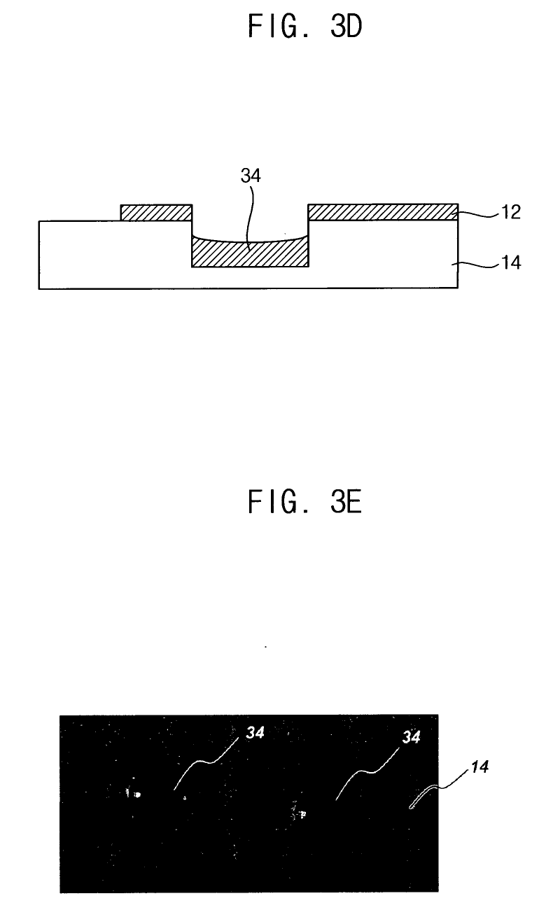

FIGS. 3A to 3E are cross-sectional views and a picture illustrating a method of repairing a void defect using an ink injection induced by a laser irradiation in accordance with a second exemplary embodiment of the present invention.

Referring to FIG. 3A, the laser irradiation 20 is carried out for the efficient ablation on the ink void 18. The irradiation 20 forms a blind hole 30 in FIG. 3B. In this exemplary embodiment, the blind hole 30 has a depth preferably larger than 1 μm but less than a thickness of the polymer substrate 14. To properly match a shape of the patterned area 12 containing the ink void 18, the shape of the blind hole 30 may be in various forms, such as circular, oval, square, rectangular and triangular.

FIG. 3C shows the application of a filler-ink 32 over the blind hole 30. Viscosity of the filler-ink 32 may be considered to properly wet and fill the blind hole 30. The filler-ink 32 in high viscosity may not wet the small blind hole and fill inside for the repair. The filler-ink 32 may be any type of inks, which may block incident UV light upon a photo lithography exposure, including but not limited to pigment or dye-based colorants in solvent or water-based solutions. Further, the filler-ink 32 may be applied by a manual method or a small injection nozzle. There are commercially available injection nozzles capable of delivering the filler-ink 32 to the localized area, including but not limited to an inkjet nozzle cartridge and a needle-type dot marker. The inkjet nozzle cartridge may have one or more nozzles, which inject droplets of the filler-ink 32 (see, for example, a manipulation of a commercially available inkjet cartridge in M. Gilliland, “Inkjet Applications,” Woodglen Press (2005)). The needle-type dot marker may deliver a dot of the filler-ink 32 through a small needle tube upon contact on the mask surface. For example, a commercially available needle-type dot marker is the DIMARK® from Hugle Electronics Inc. Toyko, Japan.

Referring to FIG. 3D, the excessive filler-ink 32 around the blind hole 30 may be wiped off, leaving a layer of a residual ink 34 at the bottom of the blind hole 30.

Referring to FIG. 3E, the PET substrate is used for a transparent substrate 14. The laser is irradiated to the PET substrate to form the blind hole 30. The irradiation 20 is performed by a circular spot in 100 μm diameter from an excimer laser at 193 nm with pulse duration about 25 ns and laser energy density at 2 J/cm². After the irradiation 20, the blind hole 30 is filled with the filler-ink 32. A portion of the filler-ink 32 around the blind hole 30 leaves the residual ink 34 in the blind hole 30. That is, to repair the void defect, a structure having the ink 34 is formed by filling and removing the filler-ink 32 only in the blind hole 30 as well as by the laser irradiation 20.

As mentioned above, when the laser irradiation for repairing the void defect 18 is performed using a pulsed laser with an irradiance below about 10⁶ W/cm², the repair of the void defect 18 may not be readily carried out. In contrast, when the laser irradiation for the efficient ablation is performed using a pulsed laser with an irradiance above about 10¹⁵ W/cm², the repair of the void defect 18 may cause damages to the substrate 14. Therefore, the laser irradiation for the efficient ablation may be performed using a pulsed laser with an irradiance of about 10⁶ W/cm² to about 10¹⁵ W/cm².

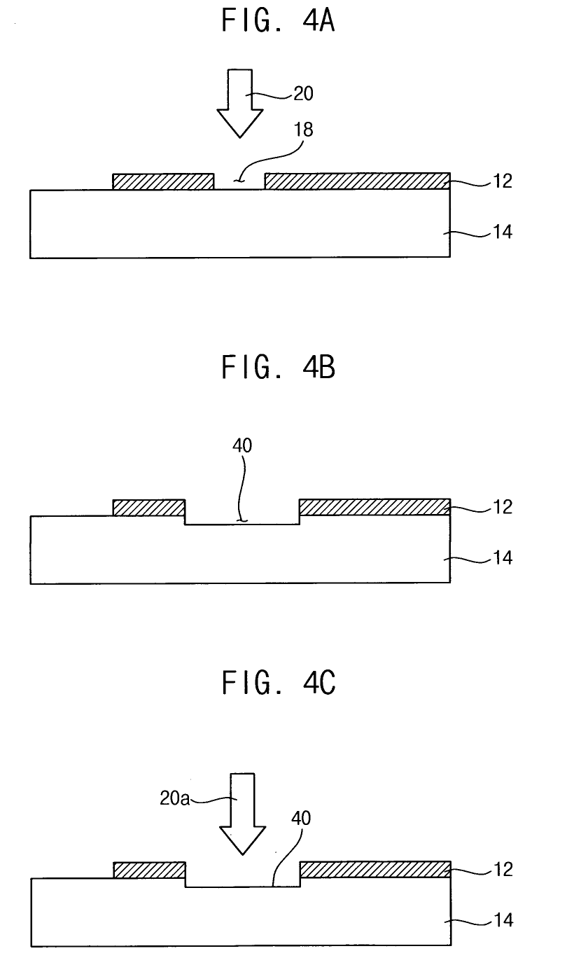

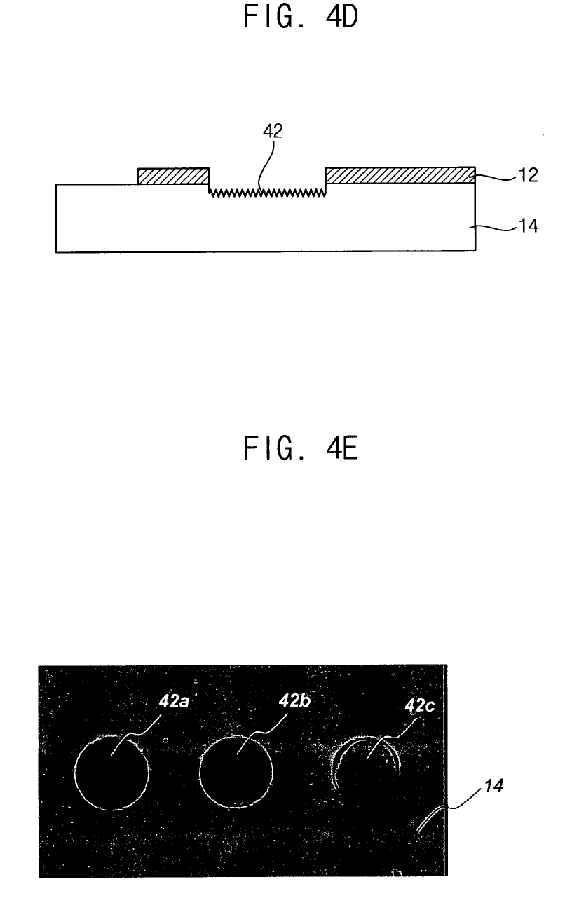

FIGS. 4A to 4E are cross-sectional views and a picture illustrating a method of repairing a void defect using a diffractive structure induced by a laser irradiation in accordance with a third exemplary embodiment of the present invention.

Particularly, the processes in the FIGS. 4A to 4E represent the method of repairing the void defect using a micro-scaled texture, i.e., the diffractive structure by the laser irradiation. The texture, properly formed by a laser ablation, may act as a diffraction grating, which traps incident light during the photolithography exposure. A degree of the light trapping and a spectrum range of the trapped light depend on a geometric factor of the diffractive structure (see the modeling of the geometric factors in M. Niggemann et. al., “Trapping Light in Organic Plastic Solar Cells with Integrated Diffraction Gratings,” 17th European Photovoltaic Solar Energy Conference Proceedings pp. 284-287 (2002)). A conical texturing, which forms micro-scaled mountains of cones, is generally known to trap incident light effectively.

Referring to FIG. 4A, the ink void 18 is under the laser irradiation 20. With reference to FIG. 4B, the laser irradiation 20 exposes the polymer surface 40 by the efficient ablation etching the patterned area 12 until the polymer surface 40 is exposed. Referring to FIG. 4C, the laser-exposed polymer surface 40 is exposed again by a controlled laser irradiation 20a. Here, the controlled laser irradiation 20a may be different from the above-mentioned laser irradiation 20.

Referring to FIG. 4D, the controlled irradiation 20a forms a micro-texture 42, which acts as a diffraction grating that traps incident light upon the lithography exposure. The controlled irradiation 20a means a laser irradiation with controlled laser parameters, including but not limited to a laser energy density, a number of pulses, a wavelength and a pulse duration. For example, when the PTE substrate is irradiated under an ArF excimer laser at 193 nm, the laser energy density at the substrate is the controlling factor to form different surface textures. That is, the initial irradiation 20 (about 20 pulses) may be performed over 1 J/cm² to effectively remove the ink from the patterned area 12 to expose the PET surface. The exposed polymer surface 40 may be irradiated again with the controlled laser energy density between 0.01 J/cm² and about 0.5 J/cm² to thereby form the conical texture. The number of pulse required to form the conical texture depends on the laser energy density. For instance, at least about 20 pulses are required to form the texture At 0.05 J/cm² (see morphology of the textures in B. Hopp et. al., “Formation of the surface structure of polyethylene-terephthalate (PET) due to ArF excimer laser ablation.” Applied Surface Science 96-8, pp. 611-616 (1996)).

Referring to FIG. 4E, three blind holes are exposed to the controlled irradiation 20a (20 pulses at 193 nm) with three different laser energy densities of 0.05 J/cm², 0.1 J/cm² and 1 J/cm² creating different micro-textures 42a, 42b and 42c, respectively. The micro-texture 42a at 0.05 J/cm² and 0.1 J/cm² forms the darkest blind hole showing a formation of the effective diffraction grating to trap incident light. In contrast, the micro-texture 42c at 1 J/cm² forms almost a transparent blind hole. This shows that the laser energy density of 1 J/cm² resulting in the micro-texture 42c does not form the effective diffraction grating.

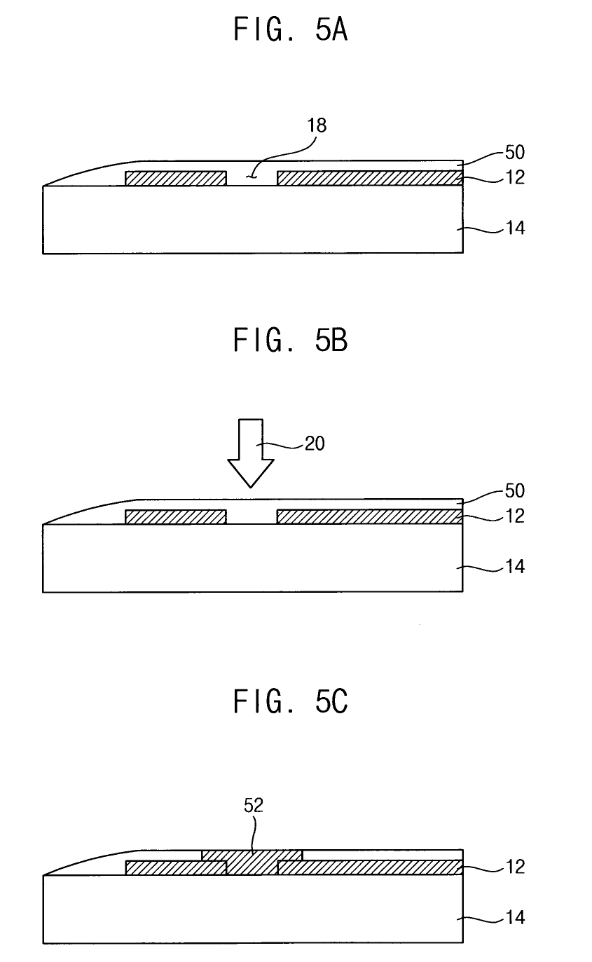

FIGS. 5A to 5C are cross-sectional views illustrating a method of repairing a void defect using a photo-printing in accordance with a fourth exemplary embodiment of the present invention.

Referring to FIG. 5A, a transparent photosensitive layer 50 is locally formed on the ink void 18. The photosensitive layer 50 may contain one kind or multiple kinds of photosensitive particles in the coating solution. The photosensitive particles, such as titanium oxide, kaolin and mica, change their colors by photochemical reaction when they are exposed to light having a certain wavelength (see U.S. Pat. No. 6,924,077 for more details). Alternatively, heat sensitive particles such as a silver nano-powder may be used where colors of the heat sensitive particles are changed by laser-induced heat from the laser irradiation 20.

For example, the photosensitive layer 50 may be a mixture of titanium dioxide (TiO₂) particle in a polymer emulsion. The particle size of the titanium dioxide is preferably small, particularly a nano-powder, which has an average particulate size of a few nanometers to hundreds of nanometers. The nano-sized particles in the emulsion transmit incident light, during a photolithography exposure, better than large particles. The emulsion preferably has a matching refractive index to the transparent polymer substrate 14. A volume percentage of the nano-titanium dioxide in the emulsion may vary from 1% to 50%, and a thickness of the mixed emulsion applied over the polymer mask 10 may range between 1 μm and 500 μm. The volume percent of the titanium dioxide may depend on a thickness of the applied emulsion. Generally, a thicker emulsion layer may require less volume percentage of the titanium dioxide. It is well known to those skilled in the art that the titanium dioxide photochemically changes color from colorless to black, when it is exposed to a pulsed UV laser.

Referring to FIG. 5B, the photosensitive layer 50 is exposed to the laser irradiation 20. In this exemplary embodiment, the laser may include a pulsed UV laser.

Referring to FIG. 5C, the exposed area 52 of the photosensitive layer 50 photochemically changes its color to prevent transmission of incident UV light during the photolithography exposure.

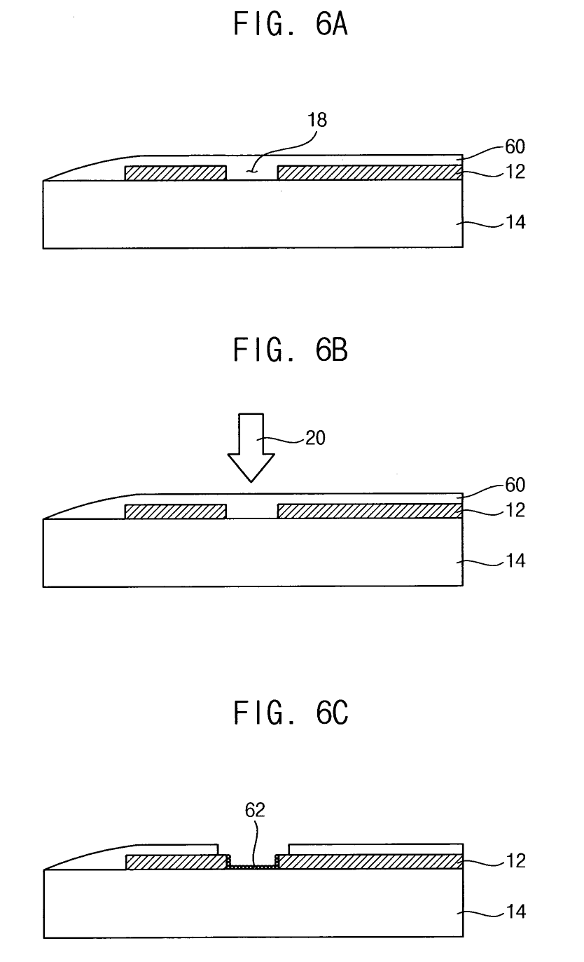

FIGS. 6A to 6C are cross-sectional views illustrating a method of repairing a void defect using laser-induced carbonization in accordance with a fifth exemplary embodiment of the present invention.

Referring to FIG. 6A, a transparent photo-reactive layer 60 is locally formed on the ink void 18. In this exemplary embodiment, the photo-reactive layer 60 may contain one kind or multiple kinds of photo-reactive particles in the coating solution. The photo-reactive particles react to an incident laser beam, and generate carbonized-debris, which darkens the irradiated area. The photo-reactive particles are preferably transparent and strongly absorbing polymers such as a polyimide. For example, the polyimide irradiated under a pulsed UV irradiation generates polycrystalline carbon that is deposited at the irradiated area. The polycrystalline carbon, formed on the bottom of the irradiated area, may significantly darken the transparent polyimide. The polyimide particles may be mixed in a polymer emulsion. The particle size of the polyimide is preferably small, in a range of a few nanometers to a few micrometers. The emulsion preferably has a matching refractive index to the transparent polymer substrate 14. A volume percentage of the polyimide particles in the emulsion may vary from 1% to 50%, and a thickness of the mixed emulsion applied over the polymer mask 10 may range between 1 μm and 500 μm. The volume percent of the polyimide particles may depend on a thickness of the applied emulsion coating. Generally, a thicker emulsion coating may require a less volume percentage of the polyimide particles. It is well known to those skilled in the art that the polyimide generates the carbonized debris under a pulsed UV laser irradiation (see, for instance, generation of carbonization in polyimide in F. Raimondi, et. al., “Quantification of Polyimide Carbonization after Laser Ablation,” Journal of Applied Physics, vol. 88 no. 6 pp. 3659-3666 (2000)).

Referring to FIG. 6B, the photo reactive layer 60 is exposed to the laser irradiation 20. In this exemplary embodiment, the laser may include a pulsed UV laser.

Referring to FIG. 6C, the photo reactive particles, exposed by the laser irradiation 20, generate a carbonized-debris 62. The darkened bottom with the carbonized-debris 62 prevents transmission of incident UV light during a photolithography exposure.

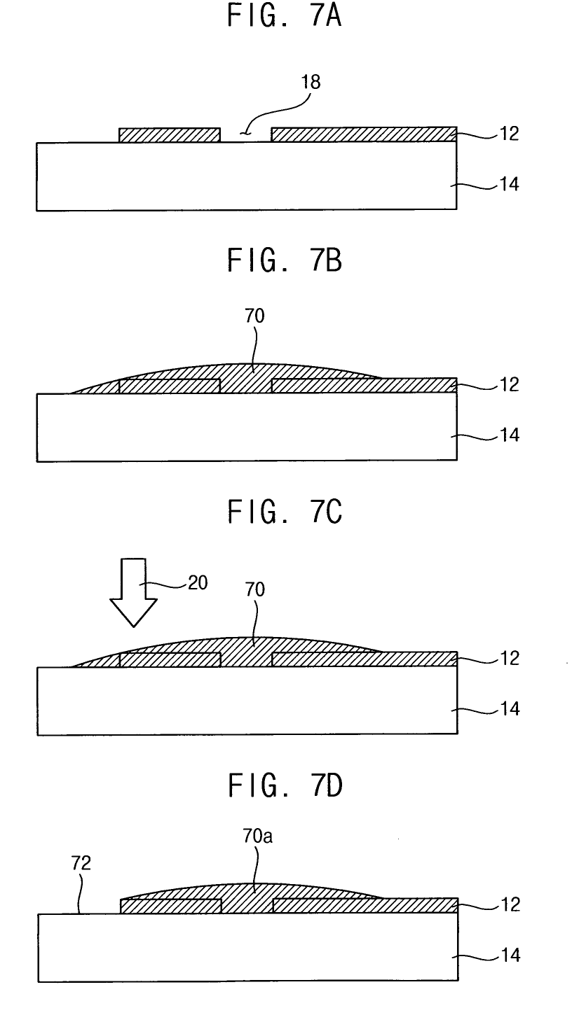

FIGS. 7A to 7D are cross-sectional views illustrating a method of repairing a void defect using a localized ink application induced by a laser trim in accordance with a sixth exemplary embodiment of the present invention.

FIG. 7A illustrates the ink void 18, and FIG. 7B illustrates a localized application of a non-transparent ink 70 over the ink void 18. The non-transparent ink 70 may be any type of inks, which may block incident UV light during a photo lithography exposure, including but not limited to pigment or dye-based colorants in solvent or water-based solutions. The non-transparent ink 70 may also be a UV curing ink, which is cured when being exposed to a UV light, and becomes insoluble. Application of the non-transparent ink 70 may be achieved by manually or by the aforementioned small injection nozzles, including but not limited to the inkjet nozzle cartridge and the needle-type dot marker. After the localized application, the ink 70 may be dried off, cured in ambient air or by other treatments, including but not limited to air/gas flow and heat. In case of the UV curing ink, it may be cured by a flood exposure to a UV lamp/LED, or by a controlled exposure to the aforementioned pulsed UV laser.

Referring to FIG. 7C, an overflow of the non-transparent, where the overflow means a flow of the ink to outside of the patterned area 12 of the polymer substrate 14, is irradiated by a laser irradiation 20 for trimming. That is, an excessive portion of a cured ink 70a from the over-application may be trimmed by the laser irradiation 20.

Here, when the laser irradiation is performed using a pulsed laser with an irradiance below about 10⁶ W/cm², the trimming may not be readily carried out. In contrast, when the laser irradiation is performed using a pulsed laser with an irradiance above about 10¹⁵ W/cm², the trimming may cause damages of the substrate 14. Therefore, the laser irradiation may be performed using a pulsed laser with an irradiance of about 10⁶ W/cm² to about 10¹⁵ W/cm².

Referring to FIG. 7D, the overflow of the cured ink 70a is selectively removed from a transparent polymer surface 72 to expose the transparent polymer surface 72.

However, when the selective removal is not practical due to slight differences in absorption coefficient between the cured ink 70a and the polymer surface 72, the laser irradiation 20 may ablate through the polymer surface 72 up to a certain depth less than 100 μm by the aforementioned efficient ablation.

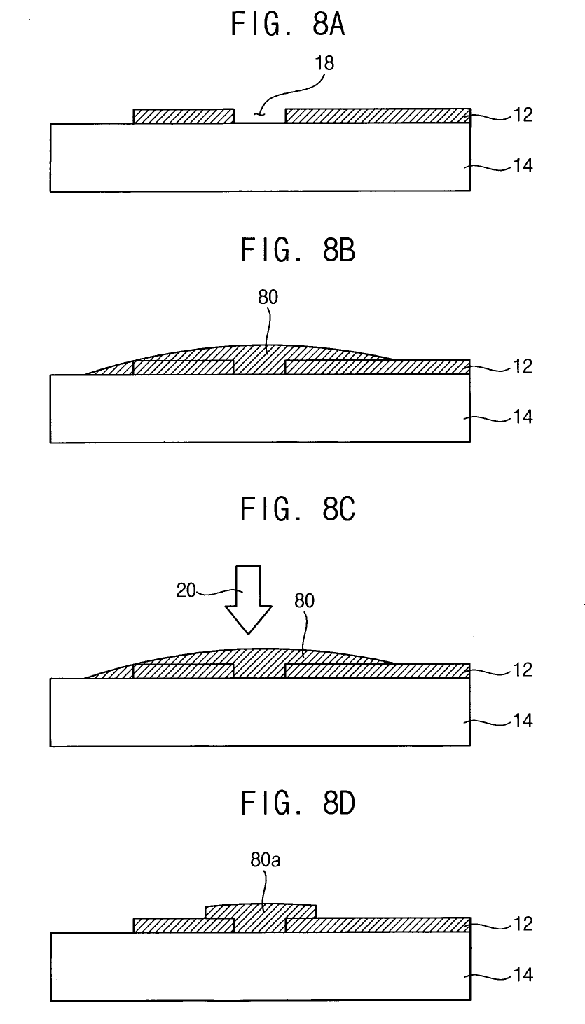

FIGS. 8A to 8D are cross-sectional views illustrating a method of repairing a void defect using a localized exposure of a UV curing ink induced by a laser irradiation in accordance with a seventh exemplary embodiment of the present invention.

FIG. 8A illustrates the ink void 18, and FIG. 8B illustrates an application of the UV curing ink 80 over the ink void 18. Upon exposing to a UV light, the UV curing ink 80 is cured and becomes insoluble. The application of the UV curing ink 80 can be achieved by manually or by the aforementioned small injection nozzles, including but not limited to the inkjet nozzle cartridge and the needle-type dot marker.

Referring to FIG. 8C, after the application of the UV curing ink 80, only a localized area above the ink void 18 may be exposed to a UV laser irradiation 20 for curing the ink 80. The irradiation 20 may be preferably from the UV pulsed laser, and preferably by a near-field imaging using a mask for forming a beam spot shape incident on the targeted area. A far-field imaging may also be used for the irradiation 20, where a beam profile of the irradiation 20 is uniform enough, such as a TEM₀₀ in Gaussian distribution. The UV laser irradiation 20 may need a lower laser energy density, preferably less than 50 mJ/cm², than that of the effective ablation.

Referring to FIG. 8D, after the irradiation 20, the excessive ink on a regions except for the cured ink 80a is removed to repair the void defect 18.

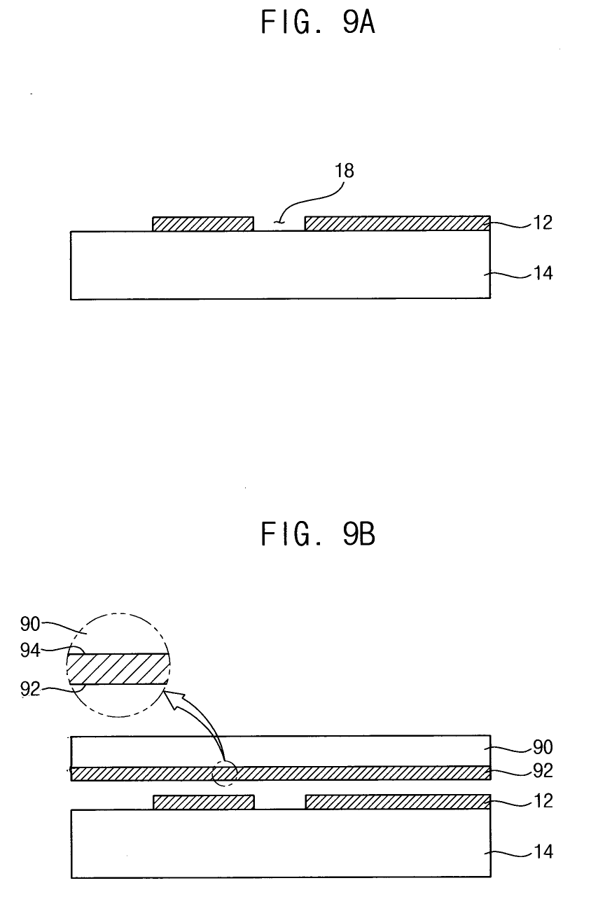

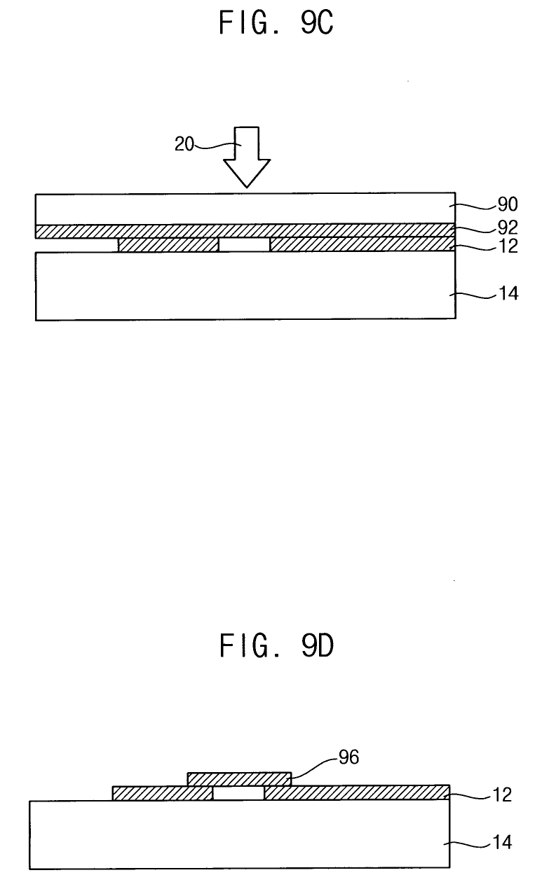

FIGS. 9A to 9D are cross-sectional views illustrating a method of repairing a void defect using a laser-induced ink transcription in accordance with an eighth exemplary embodiment of the present invention.

FIG. 9A illustrates the ink void 18. In FIG. 9B, a transparent substrate 90 with an ink layer 92 having an interface 94 is placed over the ink void 18. Here, the transparent substrate 90 may be referred to as a transparent overlay.

Referring to FIG. 9C, the ink layer 92 and the patterned area 12 are placed together, substantially in contact with each other. Then, a localized area over the ink void 18 is exposed to a laser irradiation 20, preferably from one of the pulsed UV lasers. The localized irradiation may be performed preferably by a near-field imaging using a mask for forming a beam spot shape incident on the targeted area. A far-field imaging may also be used for the irradiation 20, where a beam profile of the irradiation 20 is uniform enough, such as a TEM₀₀ in Gaussian distribution. A transparent substrate 90 may have high transmission to the laser irradiation 20. For example, at 193 nm wavelength, a fused silica maintains good optical transmission over 90%. In contrast, a soda lime glass looses its optical transmission almost down to 0% at 193 nm wavelength. When the laser irradiation 20 is from a pulsed ArF excimer laser at 193 nm, a fused silica may be used for the transparent substrate 90. The ink layer 92 may be any type of inks, which may block incident UV light during a photo lithography exposure, including but not limited to pigment or dye-based colorants in solvent or water-based solutions. The ink layer 92 may also be a colored photoresist or an emulsion with pigments. The ink layer 92 may be applied by a manual method or by a spin coating. The laser irradiation 20 transmits through the transparent substrate 90 and is absorbed at the interface 94. This selective irradiation at the interface 94 with the UV laser pulse utilizes the transmission (or absorption) difference of UV light between the transparent substrate 90 and the ink layer 92. The laser irradiation 20 may be selected to carry an energy density well below the absorption threshold of the transparent substrate 90, allowing it to transmit through without resulting in any damage. In contrast, the laser energy is high enough to cause laser-induced decomposition of the ink layer 92 at the interface 94, which causes separation of the ink layer 92 from the transparent substrate 90. Here, the separation of the ink layer 92 may be achieved by the laser irradiation using a pulsed-UV laser with a laser energy density in a range of about 0.01 J/cm² to about 10 J/cm².

Referring to FIG. 9D, the separated ink layer 96 is transferred over the ink void 18. The separated ink layer 96 may sufficiently block incident UV light during a photolithography exposure.

### INDUSTRIAL APPLICABILITY

According to the present invention, the defects such as the spot defect, the void defect, etc., in the transparent polymer mask may be readily removed using the laser. Therefore, since the above-mentioned defects may be rapidly and accurately repaired, the methods of the present invention may be effectively available for repairing the polymer mask.

Although this disclosure describes this invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

1. A method of repairing a patterned polymer substrate, comprising:
providing a transparent polymer substrate having first and second surfaces, and a patterned layer on the first surface of the polymer substrate;
detecting defects on the patterned layer and the first surface of the polymer substrate, wherein the defects include a spot defect and a void defect;
removing the spot defect by a laser irradiation; and
touching up the void defect.

2. A method of repairing a patterned polymer mask for a photolithography process, comprising:
providing a transparent polymer substrate having first and second surfaces, and a non-transparent patterned layer on the first surface of the polymer substrate;
detecting defects on the patterned layer and the first surface of the polymer substrate, wherein the defects include a spot defect and a void defect;
removing the spot defect by a laser irradiation, wherein the laser irradiation maintains transparency of the polymer substrate; and
restoring the void defect by a laser-assisted touch-up.

3. A method of repairing a defect on a patterned polymer mask for a photolithography process, comprising:
providing a transparent polymer substrate having first and second surfaces, and a non-transparent patterned layer on the first surface of the polymer substrate;
detecting a spot defect on the first surface of the polymer substrate; and
removing the spot defect by a laser irradiation, wherein the laser irradiation is sufficient to induce an effective ablation that substantially maintains transparency of the polymer substrate.

4. The method of claim 3, wherein the laser irradiation for the effective ablation is performed using a pulsed laser with an irradiance in a range of about 10⁶ W/cm² to 10¹⁵ W/cm².

5. The method of claim 3, wherein the laser irradiation is performed using a pulsed UV laser with a wavelength in a range of about 150 nm to about 400 nm.

6. The method of claim 3, wherein the laser irradiation forms a crater having a depth of about 0.1 μm to 50 μm.

7. The method of claim 6, wherein the crater has a concave shape.

8. The method of claim 6, wherein the crater is covered with a polymer emulsion that has a refractive index substantially similar to that of the polymer substrate.

9. The method of claim 3, wherein the laser irradiation is performed using a near-field imaging that uses a mask for forming a beam spot shape incident on the spot defect.

10. The method of claim 3, wherein the laser irradiation is performed using a far-field imaging that has a beam profile with a TEM₀₀ mode in the Gaussian distribution.

11. A method of repairing a defect on a patterned polymer mask for a photolithography process, comprising:
providing a transparent polymer substrate having first and second surfaces, and a non-transparent patterned layer on the first surface of the polymer substrate;
detecting a void defect on the patterned layer;
irradiating a laser to the void defect to form a blind hole; and
filling a non-transparent filler-ink in the blind hole.

12. The method of claim 11, further comprising removing an excessive amount of the filler-ink around the blind hole to fill only the blind hole with the ink.

13. The method of claim 11, wherein the laser irradiation is performed using a pulsed laser with an irradiance in a range of about 10⁶ W/cm² to 10¹⁵ W/cm².

14. The method of claim 11, wherein the laser irradiation is performed using a pulsed UV laser with a wavelength in a range of about 150 nm to about 400 nm.

15. The method of claim 11, wherein the blind hole has a depth in a range of about 1 μm to about 50 μm.

16. The method of claim 11, wherein the laser irradiation is performed using a near-field imaging that uses a mask for forming a beam spot shape incident on the void defect.

17. The method of claim 11, wherein the laser irradiation is performed using a far-field imaging that has a beam profile with a TEM₀₀ mode in the Gaussian distribution.

18. The method of claim 11, wherein filling the blind hole with the filler-ink is performed using an injection nozzle.

19. The method of claim 18, wherein the injection nozzle comprises an inkjet nozzle cartridge for delivering droplets of the filler-ink to the blind hole.

20. The method of claim 18, wherein the injection nozzle comprises a needle-type dot marker for delivering dots of the filler-ink through a needle tube adjacent to the blind hole.

21. A method of repairing a defect on a patterned polymer mask for a photolithography process, comprising:
providing a transparent polymer substrate having first and second surfaces, and a non-transparent patterned layer on the first surface of the polymer substrate;
detecting a void defect on the patterned layer;
irradiating a first laser to the void defect to expose the first surface of the polymer substrate; and
irradiating a second laser to the exposed first surface to form a diffractive structure for trapping an incident light.

22. The method of claim 21, wherein the first laser irradiation is performed using a pulsed laser with an irradiance in a range of about 10⁶ W/cm² to about 10¹⁵ W/cm².

23. The method of claim 21, wherein the first laser irradiation and the second laser irradiations are performed using a pulsed UV laser with a wavelength in a range of about 150 nm to about 400 nm.

24. The method of claim 21, wherein the first laser irradiation is performed using an ArF excimer laser at 193 nm with a laser energy density in a range of about 0.1 J/cm² to about 100 J/cm².

25. The method of claim 21, wherein the second laser irradiation is performed using an ArF excimer laser at 193 nm with a laser energy density in a range of about 0.01 J/cm² to about 0.5 J/cm².

26. The method of claim 21, wherein the first laser irradiation and the second laser irradiation are performed using a near-field imaging that uses a mask for forming a beam spot shape incident on the void defect.

27. The method of claim 21, wherein the first laser irradiation and second laser irradiation are performed using a far-field imaging that has a beam profile with a TEM₀₀ mode in the Gaussian distribution.

28. The method of claim 21, wherein the diffractive structure has a plurality of micro-scaled cones.

29. A method of repairing a defect on a patterned polymer mask for a photolithography process, comprising:
providing a transparent polymer substrate having first and second surfaces, and a non-transparent patterned layer on the first surface of the polymer substrate;
detecting a void defect on the patterned layer;
applying a transparent photo-sensitive layer to the void defect, wherein the
photo-sensitive coating includes at least one kind of photo-sensitive particles; and
irradiating a laser to the photosensitive layer to photochemically change a color of the photosensitive layer.

30. The method of claim 29, wherein the photosensitive layer comprises a mixture of titanium dioxide particles in a polymer emulsion.

31. The method of claim 30, wherein the titanium dioxide particles have an average size of about 1 nanometer to about 1,000 nanometers.

32. The method of claim 29, wherein the laser irradiation is performed using a pulsed laser with an irradiance in a range of about 10⁶ W/cm² to about 10¹⁵ W/cm².

33. The method of claim 29, wherein the laser irradiation is performed using a pulsed UV laser with a wavelength in a range of about 150 nm to about 400 nm.

34. The method of claim 29, wherein the laser irradiation is performed using a near-field imaging that uses a mask for forming a beam spot shape incident on the photo-sensitive layer.

35. The method of claim 29, wherein the laser irradiation is performed using a far-field imaging that has a beam profile with a TEM₀₀ mode in the Gaussian distribution.

36. A method of repairing a defect on a patterned polymer mask for a photolithography process, comprising:
providing a transparent polymer substrate having first and second surfaces, and a non-transparent patterned layer on the first surface of the polymer substrate;
detecting a void defect on the patterned layer;
applying a transparent photo-reactive layer to the void defect, wherein the photo-reactive layer includes at least one kind of photo-reactive particles; and
irradiating a laser to the photo-reactive layer to react the photo-reactive layer with the laser, thereby generating carbonization debris.

37. The method of claim 36, wherein the photo-reactive layer comprises a mixture of polyimide particles in a polymer emulsion.

38. The method of claim 36, wherein the laser irradiation is performed using a laser with an irradiance in a range of about 10⁶ W/cm² to about 10¹⁵ W/cm².

39. The method of claim 36, wherein the laser irradiation is performed using a pulsed UV laser with a wavelength in a range of about 150 nm to about 400 nm.

40. The method of claim 36, wherein the laser irradiation is performed using a near-field imaging that uses a mask for forming a beam spot shape incident on the photo-reactive layer.

41. The method of claim 36, wherein the laser irradiation is performed using a far-field imaging that has a beam profile with a TEM₀₀ mode in the Gaussian distribution.

42. A method of repairing a defect on a patterned polymer mask for a photolithography process, comprising:
providing a transparent polymer substrate having first and second surfaces, and a non-transparent patterned layer on the first surface of the polymer substrate;
detecting a void defect on the patterned layer;
applying a non-transparent ink to the void defect to prevent transmission of a UV light; and
irradiating a laser to the non-transparent ink to trim an overflow of the non-transparent ink beyond the patterned area on the first surface of the polymer substrate.

43. The method of claim 42, wherein applying the non-transparent ink is performed using an injection nozzle.

44. The method of claim 43, wherein the injection nozzle comprises an inkjet nozzle cartridge for delivering droplets of the non-transparent ink to the void defect.

45. The method of claim 43, wherein the injection nozzle comprises a needle-type dot marker for delivering dots of the non-transparent ink through a needle tube adjacent to the void defect.

46. The method of claim 42, wherein the non-transparent ink comprises a mixture of at least one colorant in a polymer emulsion.

47. The method of claim 42, wherein the non-transparent ink comprises a UV curing ink that is cured by an exposure to UV light including a UV lamp and a pulsed UV laser before the laser irradiation.

48. The method of claim 42, wherein the laser irradiation is performed using a pulsed laser with an irradiance in a range of about 10⁶ W/cm² to about 10¹⁵ W/cm².

49. The method of claim 42, wherein the laser irradiation is performed using a—pulsed UV laser with a wavelength in a range of about 150 nm to about 400 nm.

50. The method of claim 42, wherein the laser irradiation is performed using a near-field imaging that uses a mask for forming a beam spot shape incident on the overflow of the non-transparent ink.

51. The method of claim 42, wherein the laser irradiation is performed using a far-field imaging that has a beam profile with a TEM₀₀ mode in the Gaussian distribution.

52. A method of repairing a defect on a patterned polymer mask for a photolithography process, comprising:
providing a transparent polymer substrate having first and second surfaces, and a non-transparent patterned layer on the first surface of the polymer substrate;
detecting a void defect on the patterned layer;
applying a UV curing ink to the void defect;
irradiating a localized UV laser to the UV curing ink to change an irradiated portion of the UV curing ink into an insoluble state; and
removing a non-irradiated portion of the UV curing ink.

53. The method of claim 52, wherein applying the UV curing ink is performed using an injection nozzle.

54. The method of claim 53, wherein the injection nozzle comprises an inkjet nozzle cartridge for delivering droplets of the UV curing ink to the void defect.

55. The method of claim 53, wherein the injection nozzle comprises a needle-type dot marker for delivering dots of the UV curing ink through a needle tube to make a contact with the void defect.

56. The method of claim 52, wherein the UV laser irradiation is performed using a pulsed UV laser with a wavelength in a range of about 150 nm to about 400 nm.

57. The method of claim 52, wherein the UV laser irradiation is performed using a near-field imaging that uses a mask for forming a beam spot shape incident on the UV curing ink.

58. The method of claim 52, wherein the UV laser irradiation is performed using a far-field imaging that has a beam profile with a TEM₀₀ mode in the Gaussian distribution.

59. The method of claim 52, wherein the UV laser irradiation is performed using a pulsed UV laser with a laser energy density in a range of about 0.001 J/cm² to about 0.05 J/cm².

60. A method of repairing a defect on a patterned polymer mask for a photolithography process, comprising:
providing a transparent polymer substrate having first and second surfaces, and a non-transparent patterned layer on the first surface of the polymer substrate;
providing a transparent overlay having first and second surfaces, and an ink layer formed on the second surface of the transparent overlay, wherein the ink layer allows an interface to be formed between the transparent overlay and the ink layer;
detecting a void defect on the patterned layer;
overlapping the transparent overlay with the patterned layer of the polymer substrate to contact the ink layer to the void defect;
irradiating a localized laser to the first surface of the transparent overlay to separate the ink layer from the second surface of the transparent overlay, wherein the laser irradiation is substantially transmitted through the transparent overlay and substantially absorbed in the interface; and
transcribing the ink layer from the transparent overlay into the void defect.

61. The method of claim 60, wherein the ink layer comprises a mixture of at least one colorant in a polymer emulsion.

62. The method of claim 60, wherein the ink layer comprises a colored photoresist.

63. The method of claim 60, wherein the laser irradiation is performed using a pulsed UV laser with a wavelength in a range of about 150 nm to about 400 nm.

64. The method of claim 60, wherein the laser irradiation is performed using a near-field imaging that uses a mask for forming a beam spot shape incident on the interface.

65. The method of claim 60, wherein the laser irradiation is performed using a far-field imaging that has a beam profile with a TEM₀₀ mode in the Gaussian distribution.

66. The method of claim 60, wherein the laser irradiation is performed using a pulsed UV laser with a laser energy density in a range of about 0.01 J/cm² to about 10 J/cm².
